(19) United States
(12) Patent Application Publication
(10) Pub. No.: US 2016/0227056 A1
(43) Pub. Date: Aug. 4, 2016

(54) INFORMATION PROCESSING APPARATUS, AND METHOD

(71) Applicant: CANON KABUSHIKI KAISHA, Tokyo (JP)

(72) Inventor: Daisuke Ito, Kawasaki-shi (JP)

(21) Appl. No.: 15/009,100

(22) Filed: Jan. 28, 2016

(30) Foreign Application Priority Data
Feb. 2, 2015 (JP) 2015-018160

(51) Int. Cl. H04N 1/00; G06F 3/12; G06F 3/0481

(52) U.S. Cl. CPC H04N 1/00464; G06F 3/0481; H04N 1/00244; G06F 3/1204; G06F 3/1236; G06F 3/1287; H04N 2201/0094

(57) ABSTRACT

When a web application is caused to operate in response to an operation of a browser of a multi-function peripheral (MFP) by a user, the web application calls a print service module of the MFP to operate in coordination with the print service module. In the MFP, if the event notification module detects occurrence of a resetting operation, etc., the print service module returns an operation screen displayed on the browser to, for example, an operation screen of the web application that is the start point of the user operation, without returning the operation screen to an operation screen of the print service module.

### BACKGROUND OF THE INVENTION

1. Field of the Invention

The present invention relates to information processing apparatuses in which a plurality of applications operates in coordination with each other. As used herein, the term “application” refers to an application program for realizing a predetermined service.

2. Description of the Related Art

It is common to connect an information processing apparatus to a server apparatus on the Internet via communication therebetween and to operate a web application existing in the server apparatus from the information processing apparatus. In this case, generally, the information processing apparatus activates a browser and accesses the web application in the server apparatus via the activated browser. The server apparatus transmits to the browser HyperText Markup Language (HTML) data for displaying an operation screen of the web application. The browser displays the operation screen based on the description of the HTML data. When a user inputs an instruction to the operation screen, the browser transmits the instruction to the server apparatus to operate the web application.

In recent years, operating a web application via a browser is commonly conducted also in multi-function peripherals (MFPs). For example, Japanese Patent Application Laid-Open No. 2011-096228 discusses an MFP configured to operate a web application via a browser. In the MFP, one of a web application and an application existing in the MFP (for convenience, the application will be referred to as a “native application”) is selected and operated. However, in a case where a predetermined key such as a reset key, etc. is pressed, the web application and the native application provide the same operability to a user. Specifically, an operation content (for the user, operability) of the browser that is to be executed at the press of the predetermined key is uniform regardless of whether the web application is in operation or the native application of the MFP is in operation.

Functions of a browser include a function in which a web application running on an external apparatus calls another application existing in the apparatus via a remote procedure call (RPC), etc. to cause the called application to operate in coordination. The function is called an application coordination function. For example, an intent (Intents), which is known as one of the functions provided by “Android” (trademark of Google, Inc., U.S.A.), uses the application coordination function to coordinate applications or coordinate an application with a service.

In the MFP discussed in Japanese Patent Application Laid-Open No. 2011-096228, a web application and a native application are selectively made operable. This is different from the application coordination function. If the MFP discussed in Japanese Patent Application Laid-Open No. 2011-096228 simply employs the application coordination function, the operation content to be performed by the browser cannot be made uniform. For example, suppose that a web application calls a native application to cause the native application to operate, and in this state a reset key is pressed by a user. In this case, from a point of view of the uniform operation content of the browser, it is desirable to return to an initial screen of the web application that is a start point of the user operation. However, in reality, the screen returns to an initial screen of the native application.

### SUMMARY OF THE INVENTION

The present invention is directed to an information processing apparatus in which even in a case where a plurality of applications is caused to operate in coordination with each other, an operation content when such coordination operation ends is made uniform to improve user convenience.

According to an aspect of the present invention, an information processing apparatus executing a browser includes a setting unit configured to set a definition value defining an operation content of the browser when a coordination operation with a second application, which is a native application of the information processing apparatus, in accordance with a request from a first application used via the browser ends, a display unit configured to display a screen provided by the second application on a display device of the information processing apparatus at the time of execution of the coordination operation, and a control unit configured to execute an instruction to close the screen provided by the second application and cause the browser to perform display control according to the set definition value, in response to detection of occurrence of an end event of the coordination operation.

Further features of the present invention will become apparent from the following description of exemplary embodiments with reference to the attached drawings.

### BRIEF DESCRIPTION OF THE DRAWINGS

FIG. 1 illustrates an operation environment of a multi-function peripheral (MFP) according to an exemplary embodiment of the present invention.

FIG. 2 illustrates a hardware configuration of the MFP.

FIG. 3 illustrates a hardware configuration of a server apparatus.

FIG. 4 illustrates a functional configuration of the MFP and the server apparatus.

FIG. 5 is a flowchart illustrating a method of controlling the MFP.

FIG. 6 illustrates an example of a resetting operation definition table.

FIG. 7 illustrates an example of a web application operation screen displayed on a browser.

FIG. 8 illustrates an example of a native application operation screen displayed on a browser.

FIG. 9 illustrates an example of a printing-in-execution screen displayed on a browser.

FIG. 10 illustrates an example of service caller information.

### DESCRIPTION OF THE EMBODIMENTS

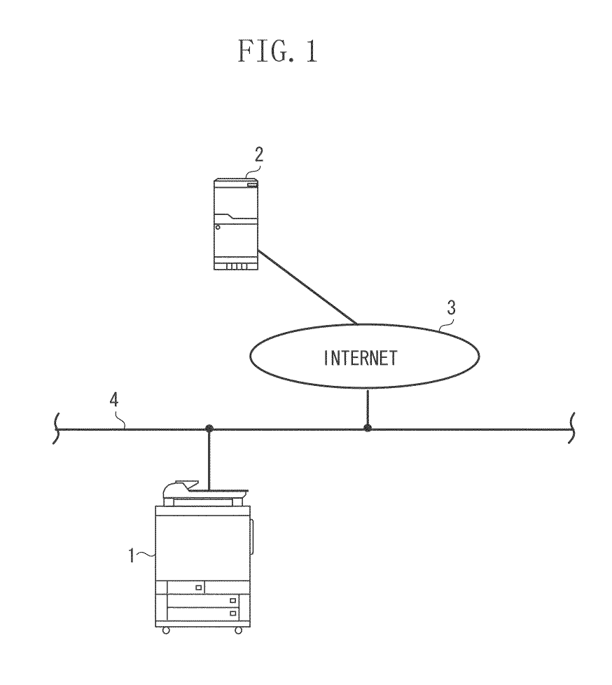

The following describes an information processing apparatus applied to a multi-function peripheral (MFP) according to an exemplary embodiment of the present invention. FIG. 1 illustrates an operation environment of the MFP according to the present exemplary embodiment. An MFP 1 is connected to a server apparatus 2 via the Internet 3 and a local network 4. The local network 4 is a network enabling communication between a device (not illustrated) including the MFP 1 and the Internet 3 in a local environment where the MFP 1 is located.

Under the environment of the local network 4, the MFP 1 is managed with a local Internet Protocol (IP) address. The IP address is an address for identifying a device that transmits and receives information in accordance with IP. Although not illustrated in FIG. 1, a gateway such as a router, etc. is located between the network 4 and the MFP 1, and address translation is performed by the gateway. The gateway includes a publicly-known firewall function to block communication from an external device to the local environment. Hereinafter, the term “network” will be used for the presence of the Internet 3, the local network 4, and the gateway unless otherwise stated.

The server apparatus 2 is an apparatus configured to hold a web application and web contents as described above in the description of the conventional technologies. The web contents are contents distributed from the server apparatus 2 in response to a request from a browser of the MFP 1.

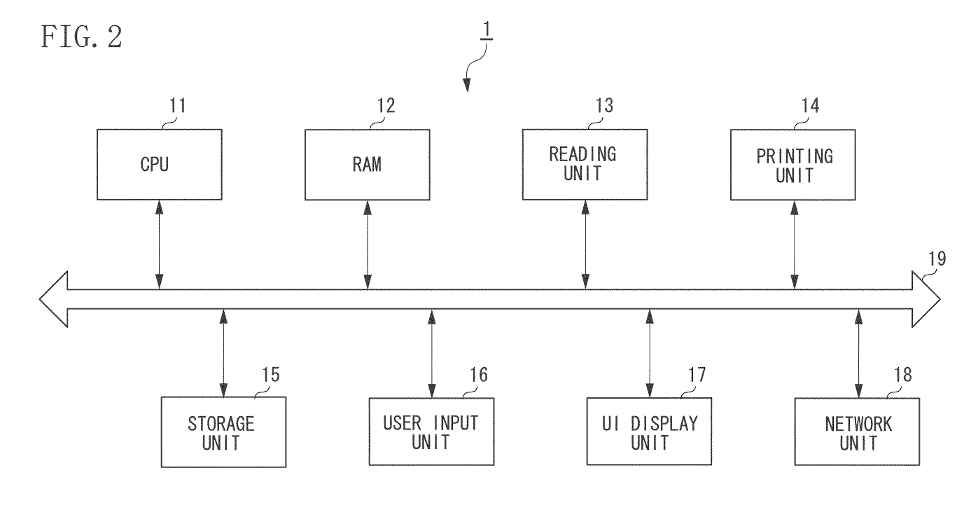

FIG. 2 illustrates an example of a hardware configuration of the MFP 1. The MFP 1 includes a central processing unit (CPU) 11, a random-access memory (RAM) 12, a reading unit 13, a printing unit 14, a storage unit 15, a user input unit 16, a user interface (UI) display unit 17, and a network unit 18, all of which are connected to a data bus 19. The CPU 11 reads and executes a computer program for the MFP to comprehensively control an entire operation of the MFP 1 that relates to a coordination operation between a plurality of applications. The RAM 12 is a work memory of the CPU 11. The reading unit 13 realizes a scanner function to read an image. The printing unit 14 performs a print service to print an image, etc. The storage unit 15 stores the computer program for the MFP, various types of setting information described below, image data, etc. The user input unit 16 receives input of a command, etc. by a user operating the MFP 1. The UI display unit 17 displays a browser described below. The user input unit 16 and the UI display unit 17 may be integrated as a display device such as a publicly-known touch panel display, etc. The network unit 18 communicates with the server apparatus 2 via the network.

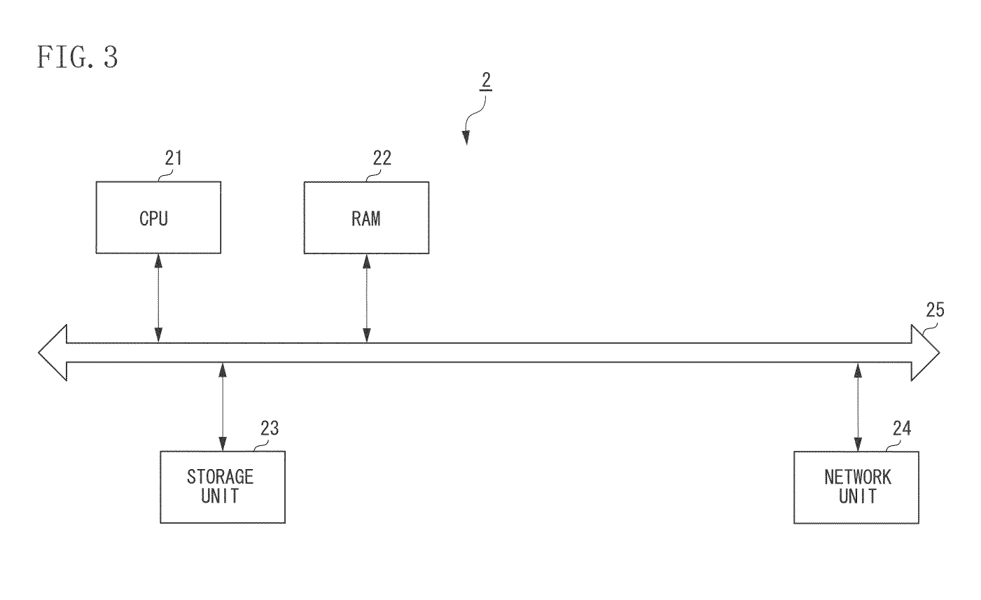

FIG. 3 illustrates an example of a hardware configuration of a part of the server apparatus 2 that is required for the implementation of the present exemplary embodiment. The server apparatus 2 includes a CPU 21, a RAM 22, a storage unit 23, and a network unit 24, all of which are connected to a main bus 25. The CPU 21 reads and executes a computer program for the server to comprehensively control a processing operation of the server apparatus 2 that relates to a coordination operation of a plurality of applications. The RAM 22 is a work memory of the CPU 21. The storage unit 23 stores the computer program for the server, various types of setting information described below, etc. The network unit 24 communicates with the MFP 1 via the network.

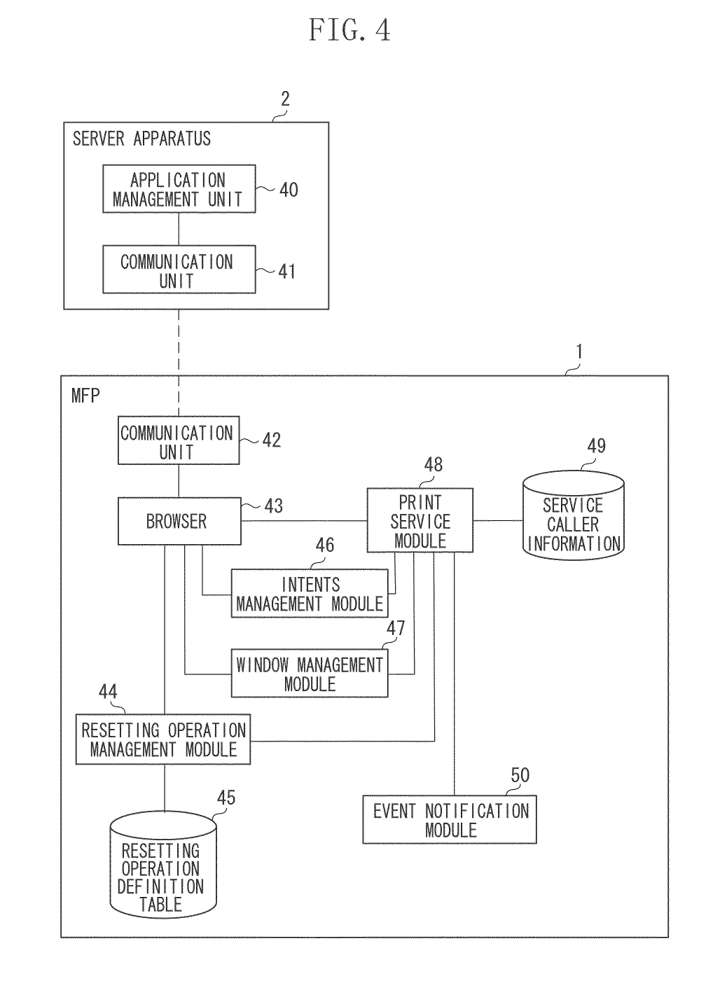

A plurality of function modules is formed in the MFP 1 and the server apparatus 2. FIG. 4 illustrates a relationship between the function modules. The CPU 11 of the MFP 1 executes a computer program for the MFP and the CPU 21 of the server apparatus 2 executes a computer program for the server, whereby each of the function modules is realized.

As illustrated in an upper section of FIG. 4, the server apparatus 2 includes an application management unit 40 and a communication unit 41. The communication unit 41 is a module configured to control the network unit 24 to perform communication in accordance with the Hyper Text Transfer Protocol (HTTP). It should be noted that HTTP is a mere example and the protocol is not limited to the communication protocol such as HTTP. The application management unit 40 is a module configured to arrange an execution environment of a plurality of applications (programs) that is to be caused to operate in coordination via a browser 43 of the MFP 1. In the present exemplary embodiment, the application management unit 40 transmits to the MFP 1 an operation screen to be displayed on the browser 43 of the MFP 1 in response to a request from the MFP 1 that has been received via the communication unit 41, whereby an operation of an application (a first application) among the plurality of web applications is enabled. Further, a request for enabling a web application and another application (a second application) present in the MFP 1 to operate in coordination is generated via the operation screen. This “another application” will be referred to as “a native application” as in the description of the conventional technologies. The term “a native application” is synonymous with “a local application,” which is commonly used in the art.

As illustrated in a lower section of FIG. 4, the MFP 1 includes a communication unit 42, the browser 43, a resetting operation management module 44, an intents management module 46, a window management module 47, a print service module 48, and an event notification module 50.

The browser 43 is a type of a web browser, and a function of the browser 43 is similar to a publicly-known function. The browser 43 according to the present exemplary embodiment communicates with the application management unit 40 of the server apparatus 2 via the communication unit 42. The same communication protocol as that of the server apparatus 2, which is HTTP in the present exemplary embodiment, is used in the communication. Then, the browser 43 downloads HTML data, an image file, etc. from the server apparatus 2 to perform layout analysis, and displays a result of the analysis on the UI display unit 17. Further, the browser 43 transmits to the server apparatus 2 information received using a predetermined input form. Specifically, information input via the operation screen is transmitted as a request to the application management unit 40. As used herein, the request refers to a request for an operation of a web application present in the server apparatus 2. Furthermore, the browser 43 receives a response (a web application operation result) from the application management unit 40, and displays the response on the operation screen.

When the requested web application calls the native application of the MFP 1 and causes the native application to operate in coordination, the resetting operation management module 44 sets to a resetting operation definition table 45 a definition value defining an operation content of the browser 43 after the coordination operation. The resetting operation definition table 45 is stored in the storage unit 15, but may be embedded in a software portion of the resetting operation management module 44.

The definition value is set to define an operation content of the browser 43 such that, for example, the last operation screen displayed immediately before the web application called the native application is displayed. Alternatively, the definition value may be set to define an operation content of the browser 43 such that one of the last operation screen, an operation screen displayed at the time of the end of the operation of the native application, and a home screen of the browser 43 is selectively displayed. The definition value is set in association with one or more web applications that call the native application. Specific examples of the definition value will be described below.

The intents management module 46 controls operations of intents present in the MFP 1. The intents are as described above in the description of the conventional technologies. A native application of the print service module 48, etc. can be read by use of the intents. For example, suppose that there is a request from an application (e.g., a web application) or a module requesting use of the print service module 48. The intents management module 46 causes such requestor and the print service module 48 to operate in coordination with each other, and returns the result to the requestor.

The window management module 47 generates a window of a module including a UI display function, such as the browser 43, the print service module 48, etc. Further, the window management module 47 performs an operation such as “open,” “close,” “move to a frontmost face,” “move to a rearmost face,” etc. on a window (including an operation screen) provided by the module according to the control by the module.

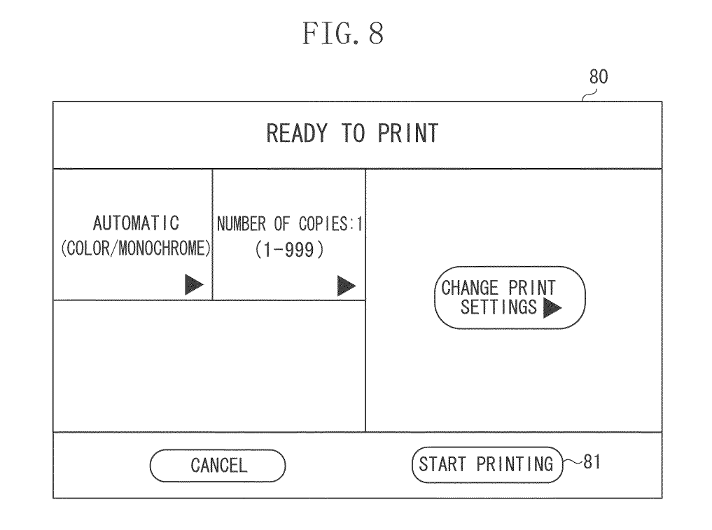

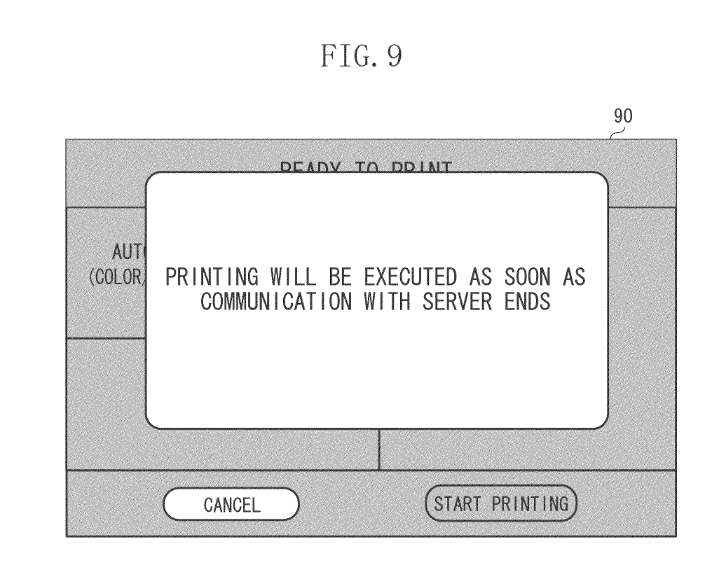

In the present exemplary embodiment, an example of a service realized by the native application is the print service module 48. The print service module 48 displays, on a display device via the browser 43, an operation screen (window) relating to print settings and execution of the printing unit 14. For example, an operation screen 80 (FIG. 8) is displayed. At the press of a “print start” button 81 on the operation screen 80 by a user, the print service module 48 changes the operation screen 80 to a printing-in-execution screen 90 (FIG. 9). Further, the print service module 48 temporarily stores information about the application having called the print service module 48 in the RAM 12 as service caller information 49 (FIG. 4). Then, if occurrence of an end event described below is detected, regardless of an operation of the called native application, the print service module 48 controls an operation of the browser 43 according to the definition value.

The service caller information 49 may be held in the print service module 48.

The event notification module 50 functions as a detection unit configured to detect occurrence of a coordination operation end event. An end event occurs due to an end of operations of the web application and the native application. The end of operations occurs not only due to a normal end but also due to a change in the state of the MFP 1 or at the press of a reset key (not illustrated). For example, an end of coordination operation occurs at the press of the reset key by the user while the operation screen provided by the print service module 48 is displayed on the frontmost face of the browser 43. Further, an end event occurs due to an end of a service (a print service in the present exemplary embodiment) provided by operations of the web application and the native application or an end of the operation of the browser 43. If occurrence of an end event is detected, the event notification module 50 notifies the print service module 48 of the occurrence of the end event.

### <Method of Controlling MFP 1>

The following describes an example of a method of controlling the MFP 1 configured as described above. When the MFP 1 causes the web application to operate via the browser 43, the web application is to call the native application and to operate in coordination. The MFP 1 sets a definition value defining an operation content of the browser 43 after the coordination operation. Then, if occurrence of a coordination operation end event is detected, whether a definition value has been set to the web application is determined. If a definition value has been set, regardless of the operation of the native application, the operation of the browser 43 is controlled according to the definition value.

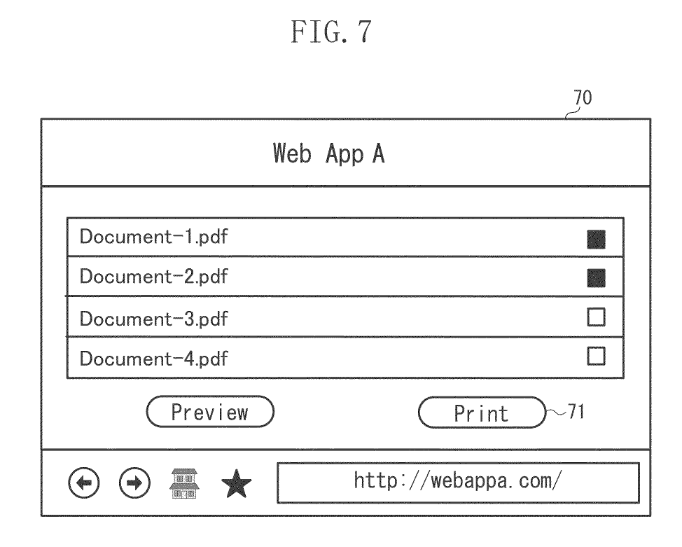

Details are as described below. In the present exemplary embodiment, the web application calls the print service module 48 via the browser 43 and an end event occurs while an operation screen 70 illustrated in FIG. 7 is displayed. If an end event occurs, the event notification module 50 notifies the print service module 48 of the occurrence of the end event.

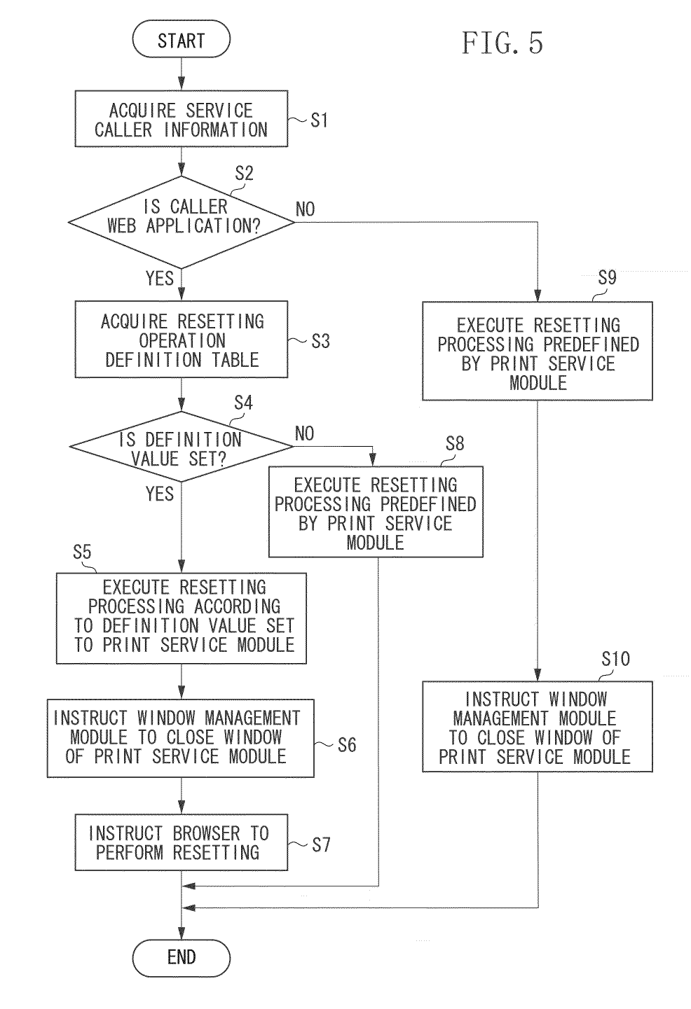

FIG. 5 illustrates an example of a process to be executed by the print service module 48 at this time.

In FIG. 5, in step S1, the print service module 48 acquires service caller information 49. Specifically, the print service module 48 identifies a caller calling the print service module 48. In the present exemplary embodiment, the caller is a web application (YES in step S2), so in step S3, the print service module 48 acquires the resetting operation definition table 45 from the resetting operation management module 44. Then, in step S4, the print service module 48 determines whether a definition value associated with the web application is set to the acquired resetting operation definition information. If the definition value is set (YES in step S4), then in step S5, the print service module 48 executes resetting processing according to the definition value set to the print service module 48 to reset the print service module 48. Then, in step S6, the print service module 48 instructs the window management module 47 to close the window of the print service module 48. Specifically, the print service module 48 instructs the window management module 47 to close the window. Then, in step S7, the print service module 48 instructs the browser 43 to perform resetting, and the processing ends. In the present exemplary embodiment, the resetting instruction in step S7 is performed according to the definition value described in the resetting operation definition table 45 acquired in step S3.

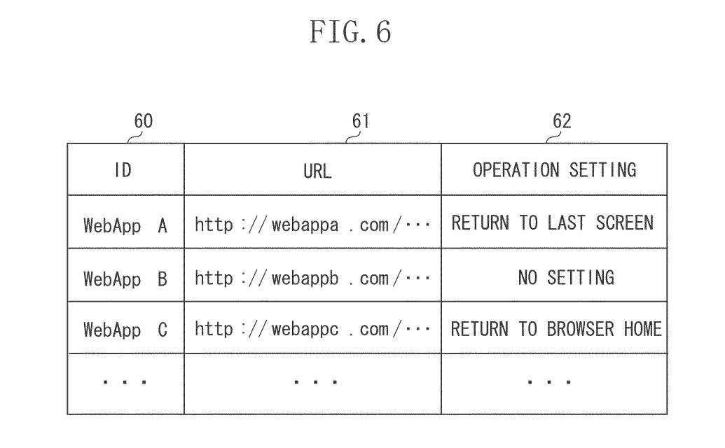

Specifically, the print service module 48 acquires an operation setting 62 corresponding to the web application that is the caller of the resetting operation definition table 45 illustrated in FIG. 6, and gives the browser 43 an instruction according to the acquired operation setting 62. For example, in a case where the web application that is the caller is a web application A, the print service module 48 instructs the browser 43 to return to the last screen. As a result, the display of the browser 43 returns to the operation screen 70 illustrated in FIG. 7. On the other hand, in a case where the web application that is the caller is a web application C, the print service module 48 instructs the browser 43 to return to a browser home. As a result, the display of the browser 43 returns not to the last screen but to a browser home screen.

In step S4, if no definition value is set (NO in step S4), then in step S8, the print service module 48 executes only the resetting processing predefined by the print service module 48, and then the processing ends. As a result, the display of the browser 43 is changed to the operation screen 80 illustrated in FIG. 8. Specifically, the print service module 48 controls an operation of the browser 43 according to a specific operation content predefined when an operation of the native application ends.

In step S2, if the caller is not a web application (NO in step S2), then in step S9, the print service module 48 executes the resetting processing predefined by the print service module 48. Then, in step S10, the print service module 48 instructs the window management module 47 to close the window of the print service module 48. Then, the processing ends. As a result, the display of the browser 43 returns to the state (the operation screen 80 in FIG. 8) in which only the foremost window on the screen 90 illustrated in FIG. 9 is closed. Specifically, in this case, the print service module 48 controls an operation of the browser 43 according to a specific operation content predefined when an operation of the native application ends.

Further, in step S7, the print service module 48 may directly instruct the browser 43 to perform the resetting based on the resetting operation definition table 45 acquired in step S3.

### <Definition Value>

FIG. 6 illustrates an example of definition values set in the resetting operation definition table 45. In this example, the definition values to be set are an identifier (ID) 60 of a web application, a uniform resource locator (URL) 61, and the operation setting 62 of the browser 43 for a case where an end event occurs. The URL is a description defining a location and an attribute of the web application. The operation setting 62 is “return to last screen,” “no setting,” or “return to browser home.” The setting “return to last screen” indicates that the screen is to return to the last screen (not always the initial screen) of the web application that was displayed immediately before the print service module 48 was called. The “last screen” is the screen 70 in FIG. 7 displayed after the processing of step S7. The setting “no setting” indicates that no specific operation is defined. In this case, the browser 43 displays the operation screen 80 illustrated in FIG. 8 after the processing of step S8. The setting “return to browser home” indicates that the screen is to return to the browser home screen set to the browser 43.

The ID 60 and the URL 61 are not limited to the examples illustrated in FIG. 6, and may be any ID and URL by which a web application can be discriminated from other applications, and that can separately record the operation setting 62 of the web applications. Further, the types of the operation setting 62 are not limited to the examples illustrated in FIG. 6. For example, the setting “return to initial screen of web application” may be set.

### <Display Screen>

The following describes the display screens illustrated in FIGS. 7 to 9. The operation screen 70 illustrated in FIG. 7 is the “last screen” described above, and the name of the web application corresponding to the ID 60, a list of documents for which the print service can be used, buttons for confirming the type of processing, etc. are displayed as a coordination operation initial screen. When the user specifies a document for which the print service is to be used and then presses a “print” button 71, the print service module 48 is called via the intents management module 46 and the operation screen 70 is displayed. In relation to FIG. 5, the screen is re-displayed after the processing of step S7.

The operation screen 80 illustrated in FIG. 8 is a screen provided by the print service module 48, and the screen is moved to the operation screen 80 from the operation screen 70 illustrated in FIG. 7. On the operation screen 80 are displayed a guide indicating that a document can be printed, color/monochrome setting, the number of copies, and link information for changing settings. At the press of the “print start” button 81 by the user, the printing unit 14 starts operation and executes the print service. In relation to FIG. 5, the screen is re-displayed after the processing of step S8.

The operation screen 90 illustrated in FIG. 9 is a screen displayed while the print service is being executed. The operation screen 80 illustrated in FIG. 8 is displayed as a background, and a window showing execution status of a coordination operation is superimposed. In this way, the current operation status of the MFP 1 can be provided to the user. In relation to FIG. 5, the screen on which only the window is closed (the operation screen 80 in FIG. 8) is displayed after the processing of steps S9 and S10.

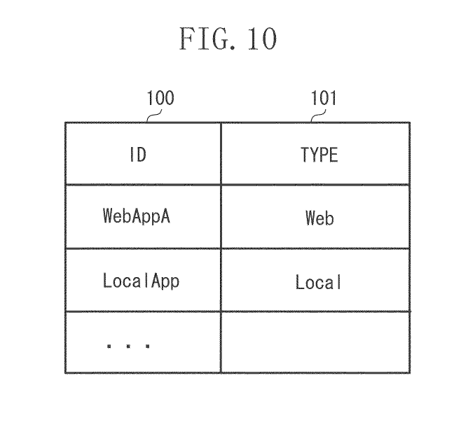

FIG. 10 illustrates an example of the service caller information 49. In the present exemplary embodiment, the service caller information 49 is an ID 100 for identifying a web application and a type 101 of the web application. Among the types 101, “Web” indicates that the caller is a web application. Further, “Local” indicates that the caller is a native application. The information about the type 101 is used in the determination performed in step S2 in FIG. 5. Specifically, if the type 101 is “Web” (YES in step S2), the processing proceeds to step S3. On the other hand, if the type 101 is “Local” (NO in step S2), the processing proceeds to step S9. The service caller information 49 is not limited to the examples illustrated in FIG. 10, and may be any information by which the ID and the type of an application can be discriminated and stored.

As the foregoing describes, in the present exemplary embodiment, even in a case where a plurality of applications ends during the coordination operation with each other, similar operability to that in a case where the applications do not operate in coordination with each other can be assured to improve user convenience. For example, in a case where the reset button is pressed during the coordination operation, the screen returns to the initial screen of the web application that is the start point of the user operation. In this way, a uniform operation feeling can be provided to the user.

While the print service module 48 corresponding to the intents is described in the present exemplary embodiment as an example of the native application of the MFP 1 that is to operate in coordination with the web application, the native application is not limited to the print service module 48. For example, the native application may be another native application that realizes a service of filing data passed from a web application for each user or distributing the data.

Further, while the exemplary case where a web application calls a native application is described in the present exemplary embodiment, an exemplary embodiment of the present invention is also applicable to a case where a native application calls another native application and to operate in coordination with the called native application. The point is to set a definition value defining an operation content of the browser 43 after the coordination operation.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-018160, filed Feb. 2, 2015, which is hereby incorporated by reference herein in its entirety.

What is claimed is:

1. An information processing apparatus executing a browser, the information processing apparatus comprising:
a setting unit configured to set a definition value defining an operation content of the browser when a coordination operation with a second application, which is a native application of the information processing apparatus, in accordance with a request from a first application used via the browser ends;
a display unit configured to display a screen provided by the second application on a display device of the information processing apparatus at the time of execution of the coordination operation; and
a control unit configured to execute an instruction to close the screen provided by the second application and cause the browser to perform display control according to the set definition value, in response to detection of occurrence of an end event of the coordination operation.

2. The information processing apparatus according to claim 1, wherein the detection of occurrence of an end event of the coordination operation occurs in response to at least one of an operation to end the second application, completion of a service provided by the first application and the second application, and an operation to end the browser.

3. The information processing apparatus according to claim 1, wherein the first application is a web application present in an external apparatus connected by communication.

4. The information processing apparatus according to claim 1, wherein the definition value is set in association with the first application.

5. The information processing apparatus according to claim 1, wherein a setting to display on the browser an operation screen displayed on the browser at the time of the request for the coordination operation from the first application to the second application is set as a setting of the definition value.

6. The information processing apparatus according to claim 1, wherein a setting to display a home screen of the browser is set as a setting of the definition value.

7. A method for an information processing apparatus executing a browser, the method comprising:
setting a definition value defining an operation content of the browser when a coordination operation with a second application, which is a native application of the information processing apparatus, in accordance with a request from a first application used via the browser ends;
displaying a screen provided by the second application on a display device of the information processing apparatus at the time of execution of the coordination operation; and
performing control to execute an instruction to close the screen provided by the second application and cause the browser to perform display control according to the set definition value, in response to detection of occurrence of an end event of the coordination operation.

8. A computer-readable storage medium on which is stored a computer program for making a computer execute a method for an information processing apparatus executing a browser, the method comprising:
setting a definition value defining an operation content of the browser when a coordination operation with a second application, which is a native application of the information processing apparatus, in accordance with a request from a first application used via the browser ends;
displaying a screen provided by the second application on a display device of the information processing apparatus at the time of execution of the coordination operation; and
performing control to execute an instruction to close the screen provided by the second application and cause the browser to perform display control according to the set definition value, in response to detection of occurrence of an end event of the coordination operation.
